(19) United States
(12) Patent Application Publication
(10) Pub. No.: US 2026/0243218 A1
(43) Pub. Date: Aug. 20, 2026

(54) FUEL SYSTEM THAT PREVENTS VAPOR LOCK IN POWERTRAINS CONVERTED TO RUN ON A VOLATILE ALTERNATIVE FUEL

(71) Applicant: ICOM North America LLC, New Hudson, MI (US)

(72) Inventors: Brandon Geoffrey Thorn, Fowlerville, MI (US); Albert Venezio, III, Walled Lake, MI (US)

(21) Appl. No.: 19/162,102

(22) PCT Filed: Sep. 25, 2024
(86) PCT No.: PCT/US2024/048262

§ 371 Date: Sep. 4, 2025

Related U.S. Application Data
(60) Provisional application No. 63/588,388, filed on Oct. 6, 2023.

(51) Int. Cl. F02M 21/02

(52) U.S. Cl. CPC F02M 21/0245; F02M 21/0233; F02M 21/0242

(57) ABSTRACT

A powertrain is adapted to operate with an alternative fuel by modifying or replacing the high pressure fuel pump to provide a pathway to return fuel from the high pressure fuel pump to a pressure vessel. The fuel return pathway allows there to be a continuous flow that effectively cools the high pressure fuel pump and prevents vapor lock. The return flow pathway is arranged so that fuel flowing into the high pressure fuel pump must flow from a first side of a low pressure chamber to a second side of the low pressure chamber, wherein the first side and the second side are on opposite sides of the high pressure fuel pump. A flow regulator may control the return fuel flow. The flow regulator may include a check valve to sustain a continuous flow and a solenoid to provide a rapid flushing of the high pressure fuel pump.

### BACKGROUND

There has long been interest in fuel conversion in the sense of adapting gasoline-fueled or diesel-fueled powertrains so as to run on an alternative fuel such as compressed natural gas (CNG), liquid natural gas (LNG), liquid propane (LPG), dimethyl ether (DME), hydrogen (H₂), ammonia (NH₃), or the like. Fuel conversion can reduce operating costs while also reducing harmful emissions. Successful fuel conversion of commercially available powertrains has proven challenging for most manufacturers.

### BRIEF DESCRIPTION OF THE DRAWINGS

Aspects of the present disclosure are best understood from the following detailed description when read with the accompanying figures.

FIG. 1 provides a schematic illustration of a powertrain in accordance with some embodiments of the present disclosure.

FIG. 2A provides a perspective view of a high pressure fuel pump according to some embodiments.

FIG. 2B provides a cutaway view of the high pressure fuel pump of FIG. 2A.

FIG. 3 provides a cutaway view of a high pressure fuel pump according to some other embodiments.

FIG. 4A provides a perspective view of a return flow regulator according to some embodiments.

FIG. 4B provides a cutaway view of the return flow regulator of FIG. 4A.

FIG. 5 provides a method of operating a powertrain in accordance with some embodiments.

FIG. 6 provides a method in accordance with some embodiments for adapting a powertrain for operation with an alternative fuel.

FIG. 7 provides a method in accordance with some other embodiments for adapting a powertrain for operation with an alternative fuel.

### DETAILED DESCRIPTION

The present disclosure provides many different embodiments or examples for various features of its systems and methods. Specific examples of components and arrangements are provided to clarify the present disclosure. These are merely examples and are not intended to limit what is claimed.

A fuel conversion of the type addressed by the present disclosure adapts a powertrain to allow a first fuel to be supplemented with or replaced by a second fuel that has a lower vapor pressure than the first fuel. A failure mode for a conversion of this type is vapor lock in a fuel pump. Vapor lock may occur when heat from combustion raises a temperature inside the fuel pump above the boiling point of the second fuel.

A high pressure fuel pump is ordinarily cooled by the fuel being pumped, however, in case of the second fuel this cooling may not be enough. Some aspects of the present disclosure relate to modifying a high pressure fuel pump so as to provide a fuel return pathway. The fuel return pathway allows the fuel amount passing through the high pressure fuel pump to be greater than the fuel amount being pumped by the high pressure fuel pump. In some embodiments, the high pressure fuel pump is the one closest to an engine of the powertrain in terms of a flow path from a fuel tank.

In some embodiments, the high pressure fuel pump includes a low pressure chamber and a compression chamber within a housing. A piston that reciprocates within the compression chamber pressurizes the fuel. A high pressure outlet receives the pressurized fuel from the compression chamber. A supply valve regulates a fuel flow from a supply port on the low pressure chamber to the compression chamber. Fuel enters the low pressure chamber through a low pressure inlet. In accordance with the present disclosure, the low pressure chamber has a low pressure outlet through which fuel exists the low pressure chamber independently from the supply port. The exiting fuel may be returned to a fuel tank.

It has been found that a high pressure fuel pump meeting the foregoing specification may nevertheless suffer vapor lock. It has been found that such a failure may be attributed to the low pressure outlet being too close to the low pressure inlet. In some embodiments, this deficiency is avoided by suitably configuring the low pressure outlet with respect to the low pressure inlet. In some embodiments, the configuration is such that a fuel flowing from the low pressure inlet to the low pressure outlet must flow from a first side of the low pressure chamber to a second side of the low pressure chamber, wherein the first side and the second side are on opposite sides of the high pressure fuel pump. In some embodiments, the configuration is such that fuel flowing from the low pressure inlet to the low pressure outlet is forced to pass from a first side of the low pressure chamber to a second side of the low pressure chamber, wherein the first side and the second side are on opposite sides of the supply port. In some embodiments, the low pressure outlet is on an opposite side of the housing from the low pressure inlet.

Some aspects of the present disclosure relate to modifying a powertrain designed to operate on the first fuel in order to accommodate the second fuel. In some embodiments, the modifications include replacing the high pressure fuel pump with one that provides a fuel return pathway. In some embodiments, the modifications include adding a fuel return pathway to an existing high pressure fuel pump. In some embodiments the modifications include forming a low pressure outlet in the housing, wherein the fuel return port opens onto the low pressure chamber. In some embodiments, the low pressure outlet has a larger inner diameter than the low pressure inlet. A large sized low pressure outlet facilitates a rapid purge.

In some embodiments, adding a fuel return pathway comprises inserting a tube through the low pressure inlet. In some embodiments, the tube extends into the low pressure chamber well beyond the low pressure inlet. In some embodiments, an inlet of the tube is on an opposite side of the low pressure chamber from the low pressure inlet with respect to the position of the supply port. Although a tube may not provide as high a flow rate as a fuel return port formed in the housing, the tube may be more easily installed. Powertrains originally manufactured so as to have the features of a powertrain modified in accordance with the foregoing description are also within the scope of the present disclosure.

If the fuel return flow rate is too low, cooling may be insufficient to prevent vapor lock. If the fuel return flow rate is too high, pressure in the low pressure chamber may drop excessively. To avoid these issues, in some embodiments a return flow regulator is provided. In some embodiments, the return flow regulator includes an orifice. In some embodiments, the return flow regulator includes a check valve.

The opening of a check valve is ordinarily controlled by fuel pressure. In some embodiments, the return flow regulator includes a solenoid that allows the check valve to be opened independently of the fuel pressure. The solenoid may allow the check valve to be opened wider and over a broader pressure range than opening by fuel pressure alone. This feature is particularly useful for hot starting. Prior to a hot start, fuel may have vaporized in the high pressure fuel pump. This vaporized fuel may need to be purged before the engine can be started. The solenoid allows this purge to be carried out quickly so that the delay before engine start is brief. In some embodiments, the powertrain includes a control system that operates the solenoid to open the check valve automatically in response to a command to start the engine.

If the return flow regulator is too far from the high pressure fuel pump, control of the fuel return flow rate may show poor responsiveness. In some embodiments, the components of the return flow regulator are rigidly attached to or integrated into the high pressure fuel pump. In some embodiments the return flow regulator is provided as a separate component from the high pressure fuel pump but is installed so as to be close to the high pressure fuel pump. In some embodiments, the return flow regulator is within about 30 cm of the high pressure fuel pump. In some embodiments, the return flow regulator is within about 15 cm of the high pressure fuel pump. Allowing the return flow regulator to be spaced apart from the high pressure fuel pump facilitates installation.

A system according to the foregoing description can eliminate most modes of vapor lock. In some powertrains, however, vapor lock may occur downstream of the high pressure fuel pump. In some embodiments, an additional mode of vapor lock is prevented by increasing the outlet pressure of the high pressure fuel pump. In some embodiments, this is accomplished by replacing the high pressure fuel pump with one that provides greater pressurization. In some embodiments, the high pressure fuel pump that provides greater pressurization is a dual stage pump. In some embodiments, this is accomplished by adding a supplemental fuel pump in series with the high pressure fuel pump. A powertrain typically includes a low pressure fuel pump that pumps fuel from a fuel supply to the high pressure fuel pump. The supplemental fuel pump may work in series with the low pressure fuel pump to provide higher pressure fuel to the high pressure fuel pump. In some embodiments, the additional fuel pump replaces the low pressure fuel pump with another that provides greater pressurization.

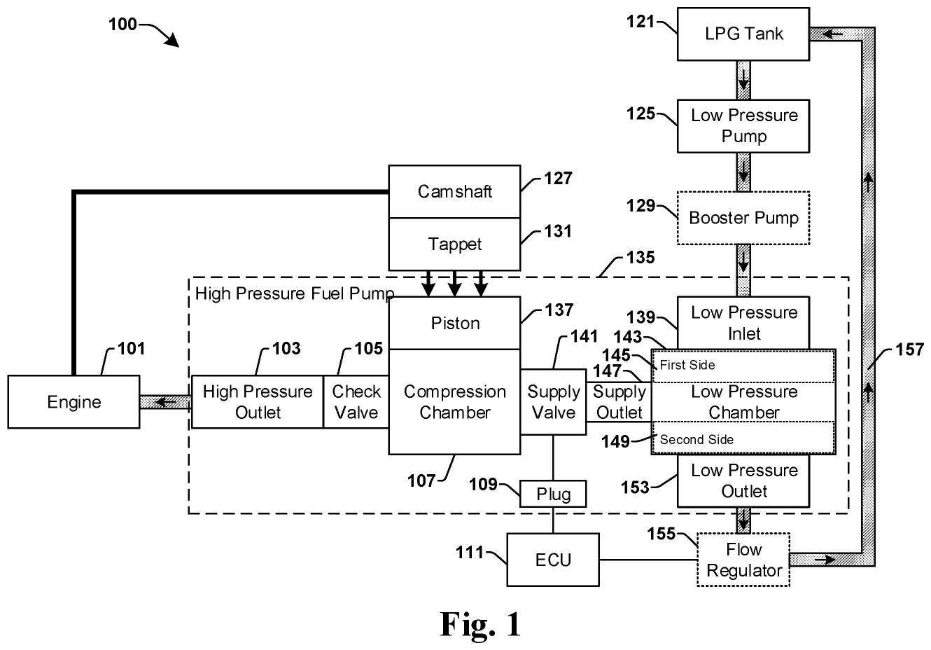

FIG. 1 provides a schematic illustration of a powertrain 100 according to some aspects of the present disclosure. In some embodiments, the powertrain 100 is part of a vehicle. The vehicle may be a car, a truck, or the like. The powertrain 100 may also be used in a generator or in some other application.

The powertrain 100 includes an internal combustion engine 101, a pressure vessel 121, a low pressure fuel pump 125, and a high pressure fuel pump 135. The low pressure fuel pump 125 pumps fuel from the pressure vessel 121 to the high pressure fuel pump 135, optionally with a pressure boost provided by a booster pump 129. The high pressure fuel pump 135 supplies the fuel to the internal combustion engine 101. The internal combustion engine 101 may be an Otto cycle engine that uses spark ignition, a Diesel cycle engine that uses compression ignition, or any other type of engine. The internal combustion engine 101 may use the fuel in a port injection system, a direct injection system, a system that combines port and direct injection, or any other type of fueling system. The powertrain 100 may also include a gasoline or diesel fuel tank and may be operable to fuel the engine 101 with either gasoline or diesel on the one hand, fuel on the other hand, or a combination of both.

The pressure vessel 121 is container adapted to hold gases or liquids at pressures substantially higher than ambient pressure. In the present context, substantially higher means at least 2 atmospheres. The pressure vessel 121 may be designed for considerably greater pressures. In some embodiments, the pressure vessel 121 is an LPG tank of the like. The fuel stored in the pressure vessel 121 may be one having a higher vapor pressure than gasoline. Examples of fuels that may be stored in the pressure vessel 121 include, without limitation, compressed natural gas (CNG), liquid natural gas (LNG), liquid propane (LPG), dimethyl ether (DME), hydrogen (H₂), ammonia (NH₃), and the like.

The high pressure fuel pump 135 includes a low pressure chamber 143 and a compression chamber 107. The fuel pumped from the pressure vessel 121 enters the low pressure chamber 143 through a low pressure inlet 139 and exits the low pressure chamber 143 for return to the pressure vessel 121 through a low pressure outlet 153. A flow regulator 155 may be positioned along a conduit 157 that connects the low pressure outlet 153 to the pressure vessel 121. Optionally, the flow regulator 155 is electronically controlled by an electronic control unit (ECU) 111.

A supply valve 141 may receive commands from the ECU 111 and controls a flow of fuel from the low pressure chamber 143 to the compression chamber 107. The supply valve 141 is connected to a supply port 147 on the low pressure chamber 143. The low pressure chamber 143 has a first side 145 and a second side 149. The low pressure inlet 139 is connected to the first side 145, the low pressure outlet 153 is connected to the second side 149, and the supply port 147 is between the first side 145 and the second side 149. As a consequence of this arrangement, the fuel flowing from the low pressure inlet 139 to the low pressure outlet 153 must flow from the first side 145 to the second side 149 and past the supply port 147.

A piston 137 reciprocates within the compression chamber 107 to compress the fuel within the compression chamber 107. A check valve 105 controls a flow of the fuel from the compression chamber 107 to the high pressure outlet 103. Once the fuel within the compression chamber 107 has reached a sufficient pressure, it passed through the check valve 105 to the high pressure outlet 103 from which the engine 101 is supplied with the fuel. The engine 101 may turn a camshaft 127, which drives a tappet 131, which actuates the piston 137.

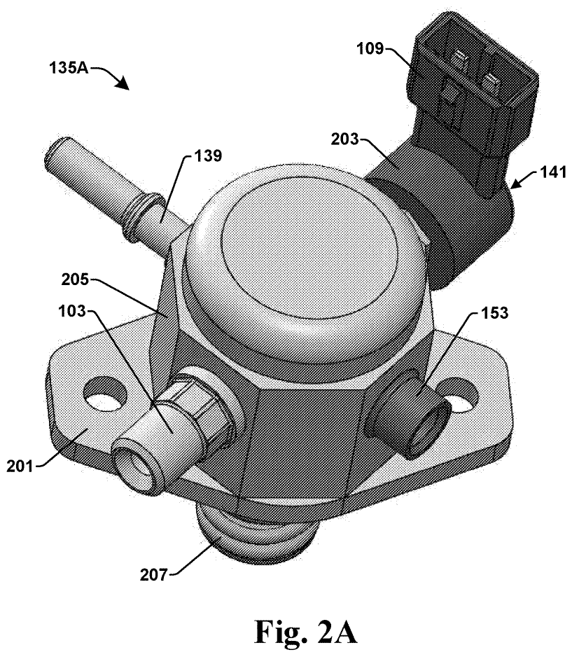

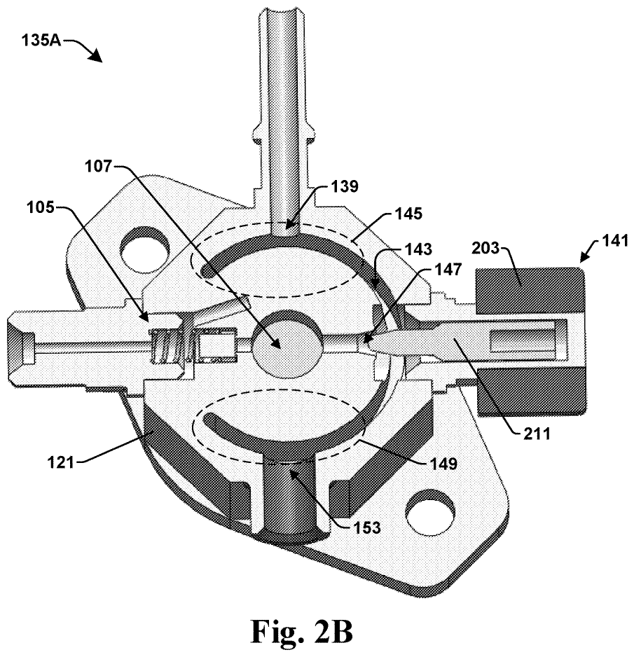

FIG. 2A provides a perspective view and FIG. 2B provides a cutaway view of a high pressure fuel pump 135A, which is an embodiment of the high pressure fuel pump 135 of FIG. 1. With reference to FIG. 2A, the low pressure inlet 139 and the low pressure outlet 153 are on opposite sides of a housing 205 of the high pressure fuel pump 135A. The supply valve 141 includes a solenoid 203 and a plug 109 for connecting with the ECU 111 (see FIG. 1). A flange 201 is provided for mounting the high pressure fuel pump 135A on the engine 101. A spring 207 is provided for biasing the tappet 131 against the camshaft 127 (see FIG. 1).

With reference to FIG. 2B, the low pressure outlet 153 is provided by a hole in the housing 205. The low pressure chamber 143 is a curved area extending between opposite side of the high pressure fuel pump 135 within the housing 205. The low pressure chamber 143 is elongated between the low pressure inlet 139, which is on the first side 145, and the low pressure outlet 153, which is on the second side 149. The supply port 147 is between first side 145 and the second side 149 and provides a seat for a pintle 211. The pintle 211 is part of the supply valve 141 and is actuated by the solenoid 203.

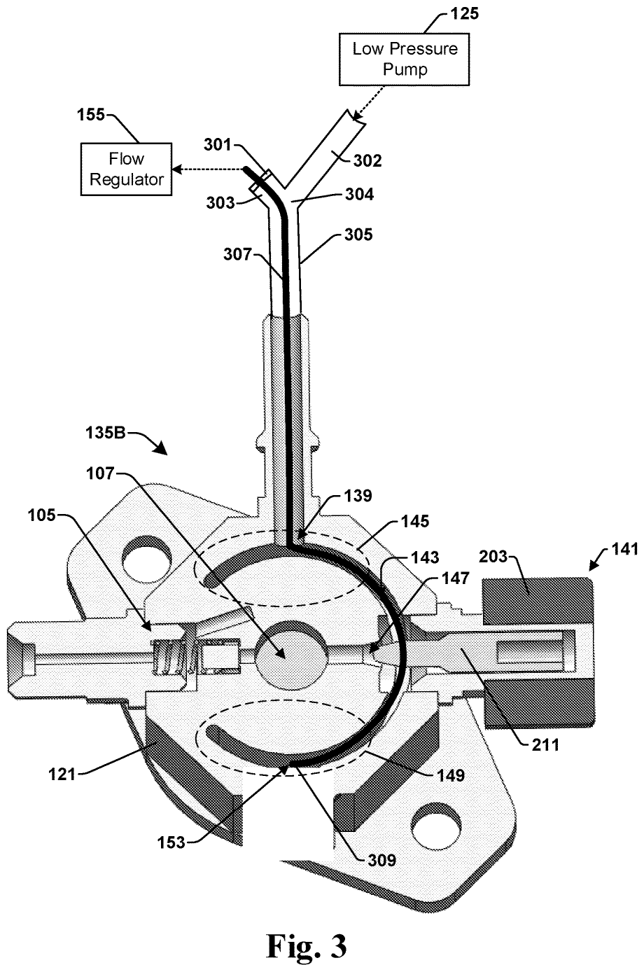

FIG. 3 provides a cutaway view of a high pressure fuel pump 135B, which is another embodiment of the high pressure fuel pump 135 of FIG. 1. In the high pressure fuel pump 135B, the low pressure outlet 153 is provided by an end 309 of a tube 307 that enters the low pressure chamber 143 through the low pressure inlet 139 and extends from the first side 145 to the second side 149 past the pintle 211 and the supply port 147. The tube 307 enters a conduit 305 connected to the low pressure inlet 139 at the low pressure inlet 139. The conduit 305 branches at a Y-shaped connector 304. The tube 307 follow a first branch 303 of the Y-shaped connector 304 to where it exits the conduit 305 through a fitting 301 and connects with the flow regulator 155. A second branch 302 of the Y-shaped connector 304 leads to the low pressure fuel pump 125.

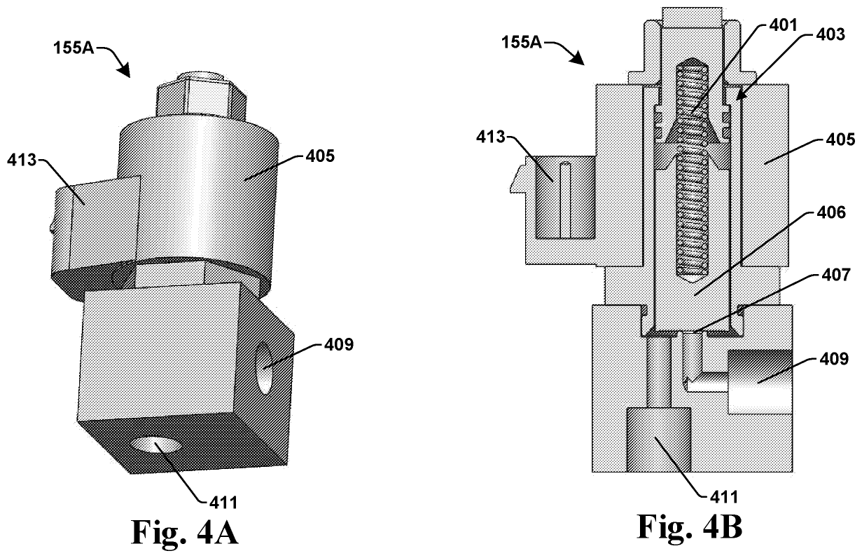

FIG. 4A provides a perspective view and FIG. 4B provides a cutaway view of a flow regulator 155A, which is an example of the flow regulator 155 of FIG. 1 in accordance with some embodiments. The flow regulator 155A includes an inlet 409 that may be coupled to the low pressure outlet 153 (see FIG. 1), an outlet 411 that may be coupled to the pressure vessel 121 (see FIG. 1), a solenoid 405, and a plug 413 through which the solenoid 405 may be operated. The flow regulator 155A includes a check valve 403 comprising a pintle 406 and a spring 401 that biases the pintle 406 against a valve seat 407. A sufficiently high pressure at the inlet 409 will overcome the force of the spring 401 and open the check valve 403. When powered, the solenoid 405 is also able to overcome the force of the spring 401 and open the check valve 403 independently of the fuel pressure. The solenoid 405 may also open the check valve 403 wider than when the check valve 403 is opened solely by pressure at the inlet 409.

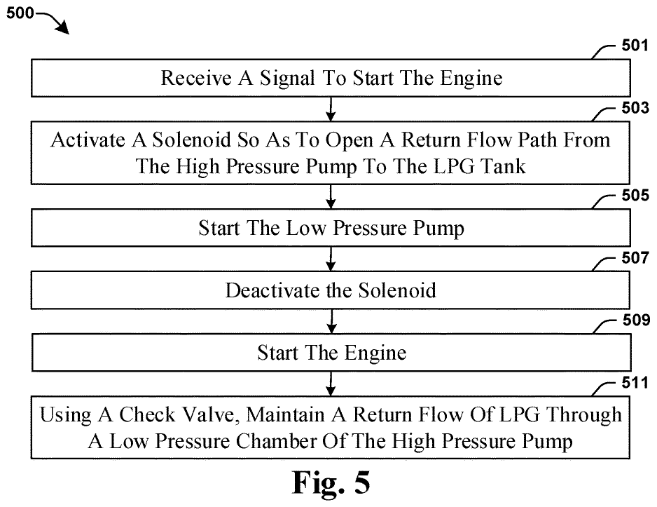

FIG. 5 provides a flow diagram for a method 500 of operating a powertrain such as the powertrain 100 of FIG. 1. While the method 500 is illustrated and described as a series of acts or events, it will be appreciated that the illustrated ordering of those acts or events is not to be interpreted in a strictly limiting sense. Acts may occur in different orders and/or concurrently with other acts where the logic of the method does not dictate otherwise. In addition, individual acts may be carried out in one or more separate acts and/or phases and not all acts may be required to implement one or more aspects or embodiments of the present disclosure. These comments also apply to the methods 600 and 700, which are described below.

The method 500 may begin with act 501, receiving a signal to start the engine. The signal may be initiated intentionally by a user pressing a start button, turning an ignition key, or the likewise. In some embodiments, the signal is initiated passively. An example of passive initiation is detecting that a door of a vehicle that includes the powertrain has been opened. The method 500 may be carried out for every start, or selectively for hot starts. A hot start condition may be detected from a temperature measurement or from an elapsed time since last engine operation.

Act 503 is activating a solenoid so as to open a return flow from a low pressure chamber of a high pressure fuel pump in the powertrain to a pressure vessel of the powertrain. Act 505 is starting a low pressure fuel pump that pumps fuel from the pressure vessel tank to the low pressure chamber. If the powertrain includes a booster pump, that may be started as well. Acts 503 and 505 together cause the high pressure fuel pump to be flushed or purged.

Act 507 is deactivating the solenoid. Act 507 is carried out after sufficient time has elapsed so that any significant vapor accumulation in the high pressure fuel pump has been flushed. In some embodiments, this time is from about 1 second to about 10 seconds. In some embodiments, this time is from about 3 second to about 5 seconds. In some embodiments, flushing would take from about 2 to about 10 times longer if flushing were to take place through the check valve without the increased check valve opening provided by the solenoid.

Act 509 is starting the engine. Starting the engine includes activating the high pressure fuel pump. A brief waiting period may be provided so that the low pressure chamber reaches a steady state pressure prior to starting the high pressure fuel pump. In some embodiments, the steady state pressure is from about 50 to about 150 psi. In some embodiments, the steady state pressure is at least about 80 psi. In some embodiments, the steady state pressure is at least about 120 psi. Higher pressures are enabled by a booster pump.

Act 511 is maintaining a continuous flow of fuel through the low pressure chamber while the engine is running. This is accomplished by operating the low pressure fuel pump and providing the check valve in the return flow regulator with a lower threshold pressure than the output of the low pressure fuel pump, or the output of the booster pump if one is provided. The steady state pressure in the low pressure chamber may be somewhat higher the check valve's threshold pressure due to resistance to flow between the low pressure chamber and the return flow regulator, but the difference may be kept small by positioning the return flow regulator close to the high pressure fuel pump. In some embodiments, the steady state pressure in the low pressure chamber is about 5 psi or less above the check valve's threshold pressure.

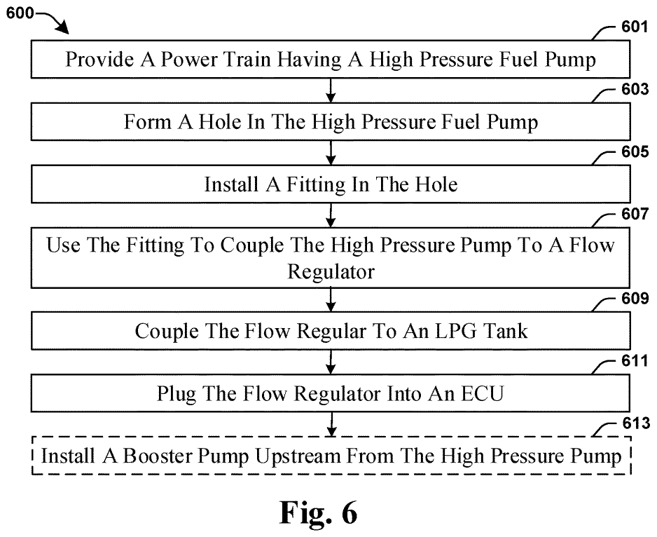

FIG. 6 provides a flow diagram for a method 600 for taking a powertrain that operates on gasoline or diesel by design and adapting it for use with an alternative fuel. The method 600 begins with act 601, providing the powertrain. The powertrain maybe an original equipment manufacturer (OEM) product installed on a vehicle. The powertrain may include an internal combustion engine, a high pressure fuel pump, and a low pressure fuel pump. The high pressure fuel pump may be of the type that has a low pressure chamber and a compression chamber within a housing, a piston that reciprocates within the compression chamber, and a supply valve that regulates fuel flow from the low pressure chamber to the compression chamber through a supply port on the low pressure chamber.

Act 603 is forming a hole in a housing of the high pressure fuel pump. The hole opens onto the low pressure chamber. The hole may be formed by drilling, boring, or any other suitable process. In some embodiments, the hole is formed opposite a low pressure inlet.

Act 605 is installing a fitting in the hole. The fitting may allow the mounting of a flow regulator, or the connecting of a conduit.

Act 607 is using the fitting to couple the low pressure chamber to an inlet side of a flow regulator. The fitting may be connected to the flow regulator by a conduit. A conduit may be a braided stainless steel hose, the like, or some other structure suitable for safely channeling fuel under pressure.

Act 609 is coupling an output of the flow regulator to a pressure vessel. The low pressure fuel pump may also be coupled to the pressure vessel. The method 600 may further include installing the pressure vessel on a vehicle.

Act 611 is plugging the flow regulator into an ECU so that the flow regulator may be electronically controlled. In some embodiments, the ECU also controls the supply valve. The ECU may be programmed with instructions for carrying out a method of operation, such as the method 500 of FIG. 5. The instructions may be stored in a memory associated with the ECU.

Act 613 is an optional step of installing a booster pump between the low pressure fuel pump and the high pressure fuel pump.

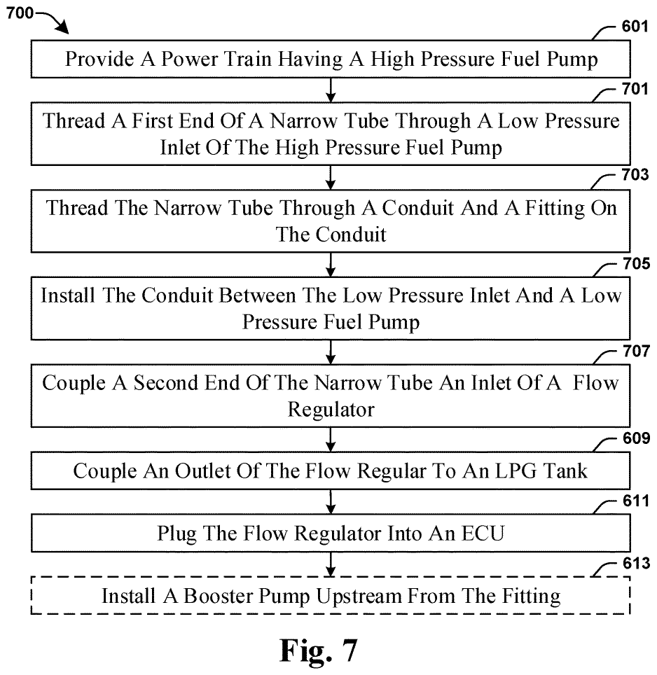

FIG. 7 provides a flow diagram for a method 700, which is another method of taking a powertrain that operates on gasoline or diesel by design and adapting it for use with an alternative fuel. Like the method 600 of FIG. 7, the method 700 begins with act 601, providing the powertrain which may be an OEM product.

Act 701 is threading the first end of a narrow tube through the low pressure inlet of the high pressure fuel pump. The narrow tube may be pushed in beyond the entrance until an end of the narrow tube reaches an opposite side of the low pressure chamber from the low pressure inlet. The opposite side may be on an opposite side of a supply port from which fuel exists the low pressure chamber when the fuel is being fed to the compression chamber. Pushing the end of the narrow tube to the opposite side may include maneuvering the narrow tube past a pintle (see FIG. 5).

Act 703 is threading the narrow tube through a conduit, and through a fitting attached to the conduit. The fitting may be a T-shaped or Y-shaped fitting and is at an opposite end of the conduit from an end that attaches to the high pressure fuel pump. The narrow tube exists the conduit through a side or branch of the fitting. A flange, gasket, or other such structure may provide sealing where the narrow tube exists the fitting.

Act 705 is connecting one end of the conduit to the low pressure inlet and the fitting at the other end the conduit to a low pressure fuel pump, which may be an OEM low pressure fuel pump or a booster pump. In this configuration, the low pressure fuel pump is able to supply the high pressure fuel pump through the conduit with a fuel flow that goes around the outside of the narrow tube.

Act 707 is coupling a second end of the narrow tube to a flow regulator. Act 609 is coupling the flow regulator to a pressure vessel. In this configuration, the narrow tube may draw fuel from the low pressure chamber and return the fuel to the pressure vessel under the control of the flow regulator. Act 611 is plugging the flow regulator into an ECU so that the ECU can exert control over the flow regulator.

Act 613 is the optional step of installing a booster pump between the low pressure fuel pump and the high pressure fuel pump. As in the method 600 of FIG. 6, this action boosts the pressure at the outlet of the high pressure fuel pump. An additional benefit which is of particular relevance in the method 700 is that the booster pump increases a pressure differential between the low pressure chamber and the pressure vessel. The increased pressure differential helps to provide an adequate cooling flow through the bottleneck of the narrow tube. It should be appreciated that the ordering of the acts in the method 700 may be varied widely.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A high pressure fuel pump, comprising:
a housing;
a low pressure chamber within the housing;
a compression chamber within the housing;
a piston that reciprocates within the compression chamber so as to pressurize fuel in the compression chamber;
a high pressure outlet that receives pressurized fuel from the compression chamber;
a supply valve that regulates fuel flow from the low pressure chamber to the compression chamber;
a low pressure inlet that admits fuel to the low pressure chamber;
a low pressure outlet that allows fuel to flow out of the low pressure chamber while fuel is flowing into the low pressure chamber from the low pressure inlet regardless of whether the supply valve is open; and
a flow regulator having an inlet fluidically couped to the low pressure outlet.

2. The high pressure fuel pump of claim 1, wherein the low pressure outlet comprises a tube that passes into the low pressure chamber through the low pressure inlet and extends to the second side.

3. The high pressure fuel pump of claim 1, wherein the low pressure outlet comprises a port in the housing on an opposite side of the housing from the low pressure inlet.

4. The high pressure fuel pump of claim 1, wherein the low pressure outlet comprises a port in the housing having a larger inner diameter than the low pressure inlet.

5. (canceled)

6. The high pressure fuel pump of claim 1, wherein the piston is actuated by a tappet.

7. A powertrain, comprising:
the high pressure fuel pump of claim 1;
a pressure vessel;
a low pressure fuel pump that pumps fuel from the pressure vessel to the low pressure inlet; and
a fuel return conduit through which the flow regulator is fluidically coupled to the pressure vessel.

8. The powertrain of claim 7, further comprising an additional fuel pump between the low pressure fuel pump and the high pressure fuel pump.

9-25. (canceled)

26. The high pressure fuel pump of claim 1, wherein the flow regulator is attached to the housing.

27. The high pressure fuel pump of claim 26, wherein the flow regulator comprises a check valve.

28. The high pressure fuel pump of claim 27, further comprising a solenoid operable to open the check valve.

29. A method of operating a powertrain comprising a pressure vessel, an engine, and a high pressure fuel pump according to claim 1, the method comprising:
storing fuel in the pressure vessel;
pumping fuel from the pressure vessel to the high pressure fuel pump;
starting the engine; and
as long as the engine is running, maintaining a continuous flow of fuel from the low pressure chamber to the pressure vessel through the flow regulator.

30. The method of claim 29, further comprising:
receiving a signal to start the engine; and
in response to the signal and prior to starting the engine, operating the flow regulator to flush the low pressure chamber.

31. The method of claim 30, wherein operating the flow regulator to flush the low pressure chamber comprises operating a solenoid.

32. The method of claim 31, wherein the flow regulator includes a check valve that enables maintaining the continuous flow of fuel from the low pressure chamber to the pressure vessel through the flow regulator when the solenoid is not operating.

33. A high pressure fuel pump, comprising:
a housing;
a low pressure chamber disposed within the housing;
a compression chamber disposed within the housing;
a piston configured to reciprocate within the compression chamber and pressurize fuel within the compression chamber;
a high pressure outlet in fluid communication with the compression chamber and configured to discharge pressurized fuel;
a supply valve configured to control fluid communication between the low pressure chamber and the compression chamber;
a low pressure inlet configured to admit fuel into the low pressure chamber;
a low pressure outlet configured to discharge fuel from the low pressure chamber, wherein the low pressure outlet permits flow from the low pressure chamber independently of the supply valve; and
a flow regulator having an inlet fluidically coupled to the low pressure outlet, the flow regulator configured to control flow from the low pressure chamber through the low pressure outlet.

34. The high pressure fuel pump of claim 33, wherein the flow regulator is configured to enable a continuous flow of fuel out of the low pressure chamber while maintaining fuel pressure in the low pressure chamber.

35. The high pressure fuel pump of claim 33, wherein the flow regulator is mounted to the housing.

36. The high pressure fuel pump of claim 35, wherein the flow regulator is mounted to the housing.

37. The high pressure fuel pump of claim 33, wherein the flow regulator is electronically controlled.

38. The high pressure fuel pump of claim 33, wherein the piston is configured to be actuated by a tappet.
